(19) United States
(12) Patent Application Publication
(10) Pub. No.: US 2026/0067170 A1
(43) Pub. Date: Mar. 5, 2026

(54) PERFORMANCE ANALYTICS FOR ASSISTING MACHINE LEARNING IN A COMMUNICATIONS NETWORK

(71) Applicant: Telefonaktiebolaget LM Ericsson (publ), Stockholm (SE)

(72) Inventors: Jing YUE, Danderyd (SE); Zhang FU, Stockholm (SE); Antonio INIESTA GONZALEZ, Madrid (ES)

(21) Appl. No.: 19/100,569

(22) PCT Filed: Jul. 24, 2023
(86) PCT No.: PCT/EP2023/070419

§ 371 Date: Feb. 2, 2025

Related U.S. Application Data
(60) Provisional application No. 63/394,499, filed on Aug. 2, 2022.

(51) Int. Cl. H04L 41/14; H04L 41/16

(52) U.S. Cl. CPC H04L 41/145; H04L 41/16

(57) ABSTRACT

A method for a network data analytics function, NWDAF, configured to assist splitting of artificial intelligence/machine learning, AI/ML, operations between a user equipment, UE, and a processing network that are operably coupled via the communication network, the method comprising receiving, from a network function, NF, or an application function, AF, associated with the communication network, a request for a processing entity, PE, performance analytic associated with the processing network, wherein the processing network comprises a plurality of PEs; for each PE in the processing network, obtaining one or more of the following information: PE resource availability, and communication performance between the PE and each other PE in the processing network; computing the PE performance analytic based on the obtained information; and sending the computed PE performance analytic to the NF or AF, in accordance with the request.

### TECHNICAL FIELD

The present application relates generally to the field of communication networks, and more specifically to techniques for assisting the configuration of artificial intelligence/machine learning (AI/ML) operations split between a user equipment (UE) and a processing network based on performance analytics for processing entities (PEs) of the processing network.

### INTRODUCTION

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NFs) that provide a wide range of different functionalities such as session management, connection management, charging, authentication, etc. One NF relevant to the present disclosure is the Network Data Analytics Function (NWDAF), which interacts with other NFs to collect relevant data and provide other NFs with network analytics information (e.g., statistical information of past events and/or predictive information). Each analytic provided by NWDAF may be uniquely identified by an analytics identifier (ID).

Machine learning (ML) is a type of artificial intelligence (AI) that focuses on the use of data and algorithms to imitate the way that humans learn, gradually improving its accuracy. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks. A subset of ML is closely related to computational statistics.

AI/ML is being used in a range of application domains across industry sectors including mobile communications. For example, user equipment (UEs, e.g., smartphones, automotive, robots) are increasingly using AI/ML models to enable applications such as speech recognition, image recognition, video processing, etc. Even so, AI/ML-based mobile applications are increasingly consuming more processing resources, memory, and stored energy (e.g., battery). Thus, there is a trend to move AI/ML model inference processing from UE to data centers in public or private clouds. For example, photos shot by a smartphone are often processed in a cloud AI/ML server before being show to a user who captured them. However, other requirements for user privacy, application responsive or latency, etc. dictate that certain parts of the AI/ML operations remain on the UE.

Thus, it is necessary and/or desirable to split AI/ML operations (e.g., inference, learning, control, etc.) between UE and network for AI/ML applications that are computation- and/or energy-intensive but also privacy- and/or delay-sensitive. 3GPP TR 22.874 (v18.2.0) specifies that AI/ML operation splitting between AI/ML endpoints is one of three types of AI/ML operations that 5GS can support.

3GPP TS 22.261 (v18.6.0) specifies that 5GS should support AI/ML-based services. For example, based on operator policy, 5GS shall provide an indication about a planned change of bitrate, latency, or reliability for a quality-of-service (QoS) flow to an authorized third party so that an AI/ML application of the third party can adjust application layer behavior if time allows.

Based on these documents, 3GPP TR 23.700-80 (v0.3.0) specifies a study on 5G system support for AI/ML-based services. At a high level, the scope of this study is for how AI/ML service providers can leverage 5GS as a platform to provide the intelligent transmission support for application layer AI/ML operation based on various objectives.

### SUMMARY

It is expected that NWDAF will play an important role in providing network performance analytics to UEs, AFs, and authorized third parties. Even so, analytics currently provided by NWDAF are derived without considering architecture, available capability (e.g., computation, communication, storage, etc.), and energy consumption, etc. in the processing network. As such, existing analytics do not provide accurate assistance for the AI/ML operations that require task offloading to the processing network, such as split AI/ML inference, learning, control, etc.

Embodiments of the present disclosure address these and other problems, issues, and/or difficulties, thereby facilitating the otherwise-advantageous deployment of application layer AI/ML that utilizes network information/analytics.

Some embodiments of the present disclosure include methods (e.g., procedures) for an NWDAF configured to assist splitting of AI/ML operations between a UE and a processing network that are operably coupled via a communication network (e.g., 5GC).

These exemplary methods can include receiving, from a network function (NF) or an application function (AF) associated with the communication network, a request for a processing entity (PE) performance analytic associated with the processing network, which includes a plurality of PEs. These exemplary methods can also include, for each PE in the processing network, obtaining one or more of the following information: PE resource availability, and communication performance between the PE and each other PE in the processing network. These exemplary methods can also include computing the PE performance analytic based on the obtained information and sending the computed PE performance analytic to the NF or AF, in accordance with the request.

In some embodiments, the PE performance analytic includes statistics and/or predictions of one or more of the following:
performance between PE pairs in adjacent layers of the processing network;
end-to-end performance through the processing network;
performance between the UE and each PE in the processing network; and
performance between the UE and a PE in a final layer of the processing network.

In some of these embodiments, the statistics and/or predictions of performance are for one or more of the following performance types: processing performance, and communication performance. In some of these embodiments, the PE performance analytic also includes predictions and/or recommendations for splitting of AI/ML operations between the UE and the processing network, including one or more of the following:
one or more PEs recommended for performing AI/ML operations offloaded from the UE,
one or more PEs recommended to receive intermediate results of UE AI/ML operations;
a number of layers in the processing network and/or a number of PEs per layer recommended for the AI/ML operations offloaded from the UE; and
a recommended split point or partition between AI/ML operations performed by the UE and AI/ML operations performed by the processing network.

Other embodiments include methods (e.g., procedures) for an AI/ML server configured to support splitting of AI/ML operations between a UE and a processing network that are operably coupled via a communication network (e.g., 5GC).

These exemplary methods can include sending, to an NWDAF associated with the communication network, a request for a PE performance analytic associated with the processing network, which includes a plurality of PEs. These exemplary methods can also include receiving the PE performance analytic from the NWDAF in accordance with the request. These exemplary methods can also include, based on the PE performance analytic, determining a split of AI/ML operations between the UE and the processing network. These exemplary methods can also include sending, to the UE and to the processing network, a configuration for the split of AI/ML operations between the UE and the processing network.

In various embodiments, the PE performance analytic can include any of the same information as the corresponding analytic summarized above for NWDAF embodiments.

In some embodiments, determining the split of AI/ML operations based on the PE performance analytic can include one or more of the following operations:
selecting one or more PEs to perform AI/ML operations offloaded from the UE;
selecting one or more PEs to receive intermediate data from the UE;
determining a number of layers in the processing network and/or number of PEs per layer to be used for the AI/ML operations offloaded from the UE;
determining a split point or partition between AI/ML operations performed by the UE and AI/ML operations performed by the processing network; and
determining a time period and/or an energy consumption budget for performing the split AI/ML operations.

In some embodiments, these exemplary methods can also include receiving from the UE a request for split AI/ML operations. In such case, the request for the PE performance analytic is based on the request from the UE. In some of these embodiments, the request from the UE includes one or more of the following information: available UE resources, UE location, processing and/or communication requirements for the split AI/ML operations, accuracy requirements for the split AI/ML operations, area of interest for the split AI/ML operations, and time window of interest for the split AI/ML operations.

Other embodiments include methods (e.g., procedures) for a processing network configured to support split AI/ML operations with a UE that is operably coupled to the processing network via a communication network (e.g., 5GC).

These exemplary methods can include receiving, from a NF or an AF associated with the communication network, one or more subscription requests for PE information for a plurality of PEs of the processing network. These exemplary methods can also include sending to the NF or AF one or more notifications including the requested PE information. These exemplary methods can also include receiving from an AI/ML server a configuration for AI/ML operations split between the UE and the processing network. The configuration is based on the PE information. These exemplary methods can also include performing, with the UE, the split AI/ML operations in accordance with the configuration.

In some embodiments, the NF or AF is the AI/ML server. In other embodiments, the NF or AF is a network exposure function (NEF). In some embodiments, the configuration for split AI/ML operations includes indications of one or more of the following:
one or more PEs to perform AI/ML operations offloaded from the UE;
one or more PEs to receive intermediate data from the UE;
a number of layers in the processing network and/or a number of PEs per layer to be used for the AI/ML operations offloaded from the UE;
a split point or partition between AI/ML operations performed by the UE and AI/ML operations performed by the processing network; and
a time period and/or an energy consumption budget for performing the split AI/ML operations.

In some embodiments, for each PE, the PE information sent can include any of the PE information summarized above in relation to AI/ML server embodiments.

Other embodiments include NWDAFs (or network nodes hosting same), AI/ML servers, and processing networks that are configured to perform the operations corresponding to any of the exemplary methods described herein. Other embodiments also include non-transitory, computer-readable media storing computer-executable instructions that, when executed by processing circuitry, configure such NWDAFs, AI/ML servers, and processing networks to perform operations corresponding to any of the exemplary methods described herein.

These and other disclosed embodiments expose beneficial assistance information to AI/ML endpoints (e.g., UE, AI/ML server, etc.), thereby enabling the AI/ML endpoints to make more accurate decisions for task offloading in split AI/ML operations. In this manner, embodiments facilitate the use of split AI/ML architectures for various applications run over a communication network (e.g., 5G network). More generally, embodiments facilitate deployment of application layer AI/ML that relies on information from a communication network (e.g., 5GC), which can improve performance of applications (e.g., OTT services) that communicate via the communication network. This can increase the value of such applications to end users and application providers.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows an exemplary AI/ML inference split between UE and network.

FIG. 4 shows an exemplary arrangement for split control of a robot via a 5G network.

FIGS. 5-6 show exemplary systems for split AI/ML operations based on offloading UE AI/ML tasks to a processing network, according to various embodiments of the present disclosure.

FIG. 7 shows a signaling diagram for an exemplary procedure for split AI/ML operations based on NWDAF-generated PE performance analytics, according to various embodiments of the present disclosure.

FIG. 8 shows an exemplary method (e.g., procedure) for an NWDAF, according to various embodiments of the present disclosure.

FIG. 9 shows an exemplary method (e.g., procedure) for an AI/ML server, according to various embodiments of the present disclosure.

FIG. 10 shows an exemplary method (e.g., procedure) for a processing network, according to various embodiments of the present disclosure.

FIG. 11 shows a communication system according to various embodiments of the present disclosure.

FIG. 12 shows a UE according to various embodiments of the present disclosure.

FIG. 13 shows a network node according to various embodiments of the present disclosure.

FIG. 14 shows host computing system according to various embodiments of the present disclosure.

FIG. 15 is a block diagram of a virtualization environment in which functions implemented by some embodiments of the present disclosure may be virtualized.

FIG. 16 illustrates communication between a host computing system, a network node, and a UE via multiple connections, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, mobile terminals (MTs), etc.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device.
Service: As used herein, the term “service” refers generally to a set of data, associated with one or more applications, that is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

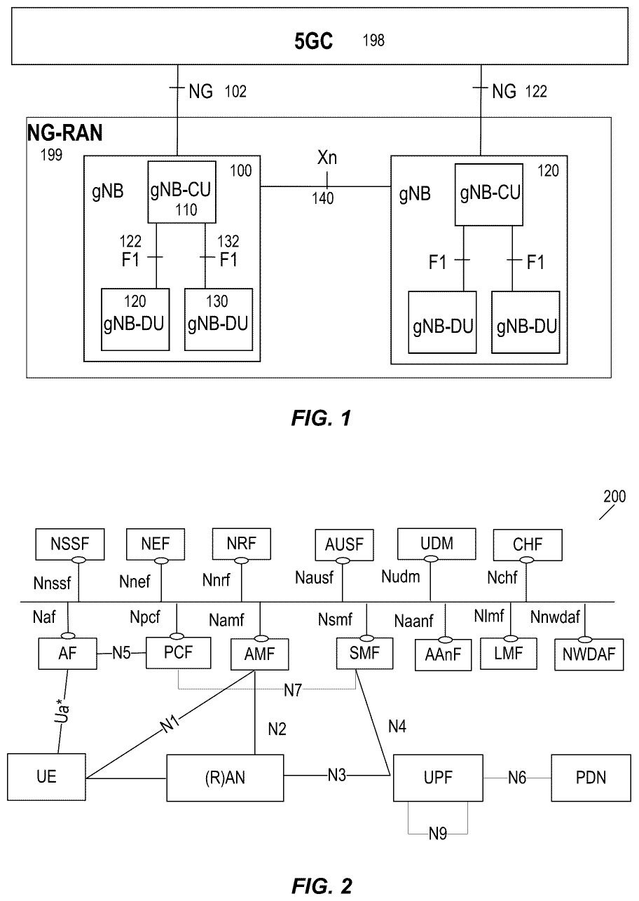

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services. Furthermore, the services are composed of various “service operations”, which are more granular divisions of the overall service functionality.

FIG. 2 shows an exemplary non-roaming architecture of a 5G network (200) with service-based interfaces. This architecture includes the following 3GPP-defined NFs:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)-supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface-acts as the entry point into operator's network, by securely exposing to AFs (e.g., within or outside of 5GC) the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface-provides service registration and discovery, enabling NFs to identify appropriate services available from other NFs.
Network Slice Selection Function (NSSF) with Nnssf interface-a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface-based in a user's home network (HPLMN), it performs user authentication and computes security key materials for various purposes.
Network Data Analytics Function (NWDAF) with Nnwdaf interface-provides network analytics reports (e.g., statistical information of past events and/or predictive information) to other NFs on a network slice instance level. The NWDAF can collect data from any 5GC NF. Any NF can obtain analytics from an NWDAF using a DCCF and associated Ndccf services. The NWDAF can also perform storage and retrieval of analytics information from an Analytics Data Repository Function (ADRF).
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

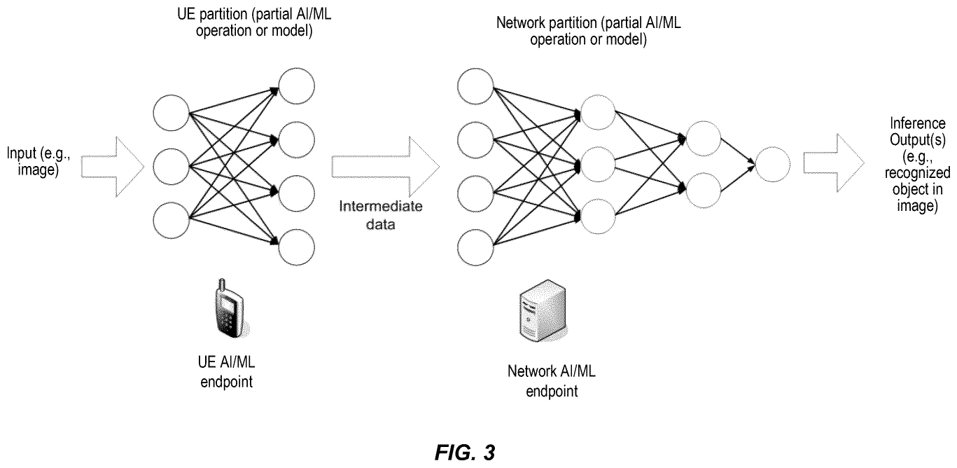

As briefly mentioned above, 3GPP TR 22.874 (v18.2.0) specifies that 5GS can support three different types of AI/ML operations: AI/ML operation (e.g., inference) split between AI/ML endpoints; AI/ML model/data distribution and sharing over 5GS; and distributed/Federated Learning over 5GS. FIG. 3 shows an exemplary AI/ML inference split between UE and network. In this exemplary arrangement, the AI/ML operation/model is split into multiple parts according to the current task and environment. The intention is to offload the computation- and energy-intensive parts to endpoint(s) in the network, while leaving the privacy- and delay-sensitive parts in the UE.

In FIG. 3, the UE endpoint obtains the input (e.g., an image) and executes a partition of the AI/ML operation (or model), for example up to a specific layer. The UE then sends the intermediate data output by its partition to the corresponding network AI/ML endpoint, which executes the remaining parts (or layers) and returns inference results to the UE. Although FIG. 3 shows a single network AI/ML endpoint that executes a single network partition, it is possible to have multiple network AI/ML endpoints that execute respective partitions of the AI/ML model, based on intermediate results from the UE or from a preceding network AI/ML endpoint.

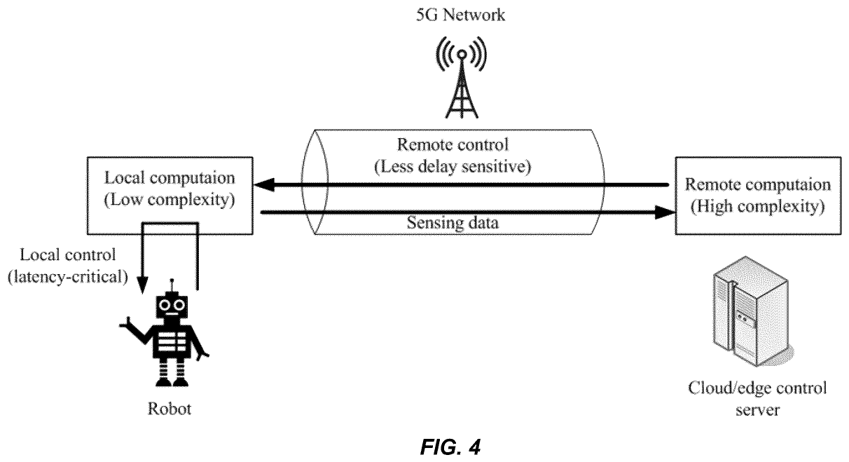

FIG. 4 shows an exemplary arrangement for split control of a robot via a 5G network. In this arrangement, a part of the algorithm that is more complex but less delay-sensitive is offloaded to remote processing entities in the cloud or edge control server. In particular, the sensing data is sent to the remote server for processing, and the error feedback data for lower-complexity but latency-sensitive control is returned to the robot for local processing.

In some cases, the robot may not receive the error feedback data from the remote server due to communication delays or packet loss. In such cases, the robot can approximate the error feedback data using feedback matrices that were pre-computed or previously received. This will enable the feedback control for some duration while communication is lost, such that the robot can still operate safely.

As briefly mentioned above, 3GPP TS 22.261 (v18.6.0) specifies that 5GS should support AI/ML-based services. For example, based on operator policy, the 5GS shall allow an authorized third-party to monitor resource utilization of the network service associated with the third-party. Note that resource utilization in this context refers to measurements relevant to a UE's performance, such as data throughput provided by the network to the UE.

Furthermore, based on operator policy, 5GS shall provide an indication about a planned change of bitrate, latency, or reliability for a quality-of-service (QoS) flow to an authorized third party so that an AI/ML application of the third party can adjust application layer behavior if time allows. The indication shall provide expected time and location of the change, as well as target QoS parameters. The 5G system shall expose aggregated QoS parameter values for a group of UEs to an authorized third party and enable the authorized third party to change aggregated QoS parameter values associated with the group of UEs, e.g., UEs of a federated learning (FL) group.

Also, based on operator policy, 5GS shall provide means to predict and expose predicted network condition (e.g., of bitrate, latency, reliability) changes per UE, to the authorized third party. Subject to user consent, operator policy, and regulatory constraints, 5GS shall expose monitoring and status information of an AI/ML session to a third-party AI/ML application. For example, this can be used by the AI/ML application to determine an in-time transfer of an AI/ML model.

Additionally, the 5GS shall provide alerting about events (e.g., traffic congestion, UE moving into/out of a different geographical area, etc.) to authorized third parties, together with predicted time of the event. For example, a third-party AI/ML application may use the prediction information to minimize disturbance in the transfer of learning data and AI/ML model data.

As briefly mentioned above, 3GPP TR 23.700-80 (v0.3.0) specifies a study on 5G system support for AI/ML-based services. At a high level, the scope of this study is for how AI/ML service providers can leverage 5GS as a platform to provide the intelligent transmission support for application layer AI/ML operation based on various objectives. One specific objective is to study the possible architectural and functional extensions to support the application layer AI/ML operations defined in 3GPP TS 22.261 (v18.6.1), specifically:
Monitoring of network resource utilization in the 5G system relevant to the UE in order to support application layer AI/ML operation.
Whether and how to extend 5GS information exposure for 5GC NF(s) to expose UE and/or network conditions and performance prediction (e.g., location, QoS, load, congestion, etc.) to the UE and/or to the authorized 3^{rd} party to assist the application layer AI/ML operation.
Enhancements of external parameter provisioning to 5GC (e.g., expected UE activity behavior, expected UE mobility, etc.) based on application layer AI/ML operation.
Enhancements of other 5GC features that could be used to assist the application layer AI/ML operations as described in 3GPP TS 22.261 (v18.6.1) section 6.40.

Another objective is to study possible QoS policy enhancements needed to support application layer AI/ML operational traffic while supporting other user traffic in the 5GS. Another objective is to study whether and how 5GS can provide assistance to an AF and to AF-associated UEs, as well as how to manage FL and model distribution/redistribution (i.e., FL members selection, group performance monitoring, adequate network resources allocation and guarantee, etc.) to facilitate collaborative application layer AI/ML-based FL operation between application servers and application clients running on UEs.

It is expected that NWDAF will play an important role in providing network performance analytics to UEs, AFs, and authorized third parties. Even so, analytics currently provided by NWDAF are derived without considering architecture, available capability (e.g., computation, communication, storage, etc.), and energy consumption, etc. in the processing network. One such existing analytic is Data Network (DN) Performance. Because existing analytics do not take this information into account, they do not provide accurate assistance for the AI/ML operations that require task offloading to the processing network, such as split AI/ML inference, learning, control, etc.

Embodiments of the present disclosure address these and other problems, issues, and/or difficulties by a new analytic (e.g., PE Performance) or an extension of an existing analytic (e.g., DN Performance) that provides processing entity (PE) performance analytics for assisting AI/ML operations, taking into account architecture, available capacity (e.g., computation, communication, storage, etc.), and energy consumption in the processing network. The analytic output may include statistics/predictions of one or more of the following:
performance between PE pairs in adjacent layers;
end-to-end performance through the processing network;
performance between a UE and each PE in the processing network; and
performance between a UE and a PE in the final layer of the processing network.
   Each of the statistics/predictions of performance may related to communication performance (e.g., latency, throughput, packet loss rate, etc.) and/or processing performance (e.g., computation or processing latency, storage availability, energy consumption, etc.).

In some embodiments, the analytic output may also include predictions and/or recommendations for splitting of AI/ML operations, such as which PEs to perform the offloaded operations, number of layers, splitting point, which PE(s) to receive UE intermediate results, etc.

The novel analytic with any of the above-listed information can assist AI/ML endpoints (e.g., UE, AI/ML application server, etc.) to make more accurate decisions for task offloading in split AI/ML operations (e.g., inference, learning, control, etc.).

Embodiments can provide various benefits and/or advantages. For example, by exposing required assistance information to AI/ML endpoints (e.g., UE, AI/ML application server, etc.), embodiments enable the AI/ML endpoints (e.g., UE, AI/ML application server, etc.) to make more accurate decisions for task offloading in split AI/ML operations. In this manner, embodiments facilitate the use of split AI/ML architectures for various applications run over a communication network (e.g., 5G network).

Some typical application layer AI/ML use cases include image/media/speech recognition, media quality enhancement, automotive networked applications, split control, etc. In these various use cases, there can be various splits of functionality between the AI/ML endpoints (e.g., UE, authorized third party). Furthermore, some application layer AI/ML operations require several rounds for completion, with one round being a transaction between AI/ML endpoints (e.g., client and server) along with the corresponding processes at the AI/ML endpoints. For example, one round could be the server sending data to the client(s), which performs computation on the data and returns some results to the server. The data sent and results returned can include raw data (e.g., images, video, audio, tasks, sensor data, etc.), intermediate ML parameters (e.g., weights, gradient, etc.), ML models, ML model topology, etc. Each round may exchange different data and results, e.g., as the application layer AI/ML operations proceed toward completion.

Thus, the AI/ML endpoints may have various requirements for information about network conditions, etc. needed to perform their respective application layer AI/ML operations. In various embodiments, the AI/ML endpoints may request and obtain from 5GC different assistance information for their various application layer AI/ML operations.

However, it is expected that the number of application layer AI/ML use cases will continue to increase, along with the corresponding need for information from 5GC. This places an increasing burden on 5GC to understand all requests from AI/ML endpoints and provide corresponding assistance information. These challenges can be addressed by embodiments of the present disclosure.

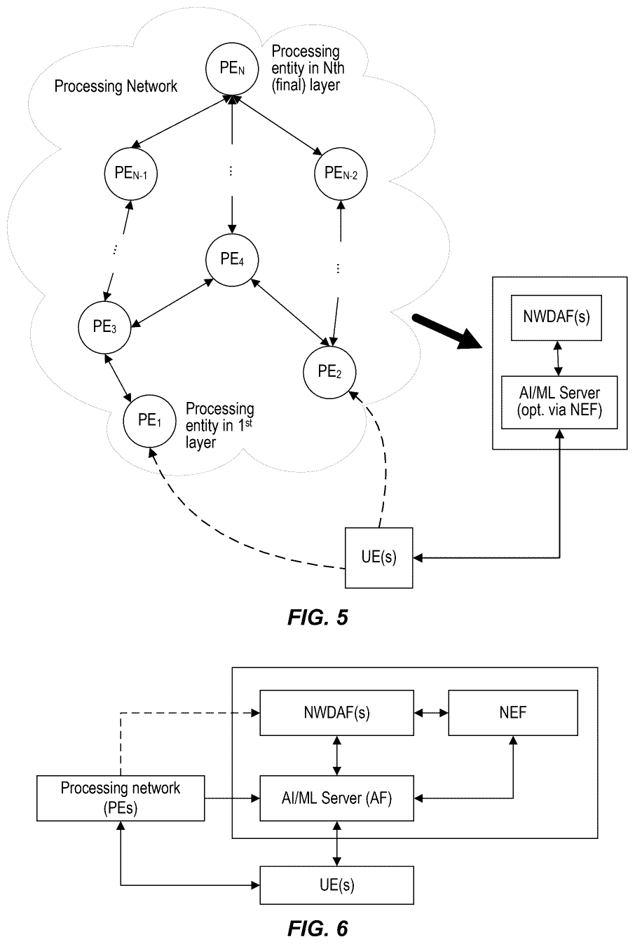

FIG. 5 shows an exemplary system for split AI/ML operations based on offloading AI/ML tasks to a processing network with N layers of PEs, according to various embodiments of the present disclosure. In the system shown in FIG. 5, the UE offloads AI/ML tasks to PE(s) in the first layer (or layer 1), which process a first partition of the AI/ML tasks before sending an intermediate result to PE(s) in a second layer (or layer 2). This is repeated until a final layer (layer N) of PEs, which generate final results of the AI/ML operations to be sent to the UE.

In the arrangement shown in FIG. 5, the UE triggers the split AI/ML operations. The UE and an AI/ML server (which can be an AF) perform application-layer negotiations for the split AI/ML operations. The AI/ML server needs assistance information from 5GC to make decisions for the split AI/ML operations, such as the architecture and available resources of the processing network that will handle split AI/ML operations offloaded from the UE.

The AI/ML server requests/subscribes to one or more NWDAFs for AI/ML assistance information analytics. The AI/ML server may request or subscribe to a specific PE performance analytic, which can be called PE Performance, DN Performance, or something similar. The NWDAF may collect information about PEs of the processing network (e.g., cloud/edge servers, etc.) from the PEs directly (e.g., as respective AFs) or indirectly (e.g., via NEF). The information collected from the PEs can include one or more of the following:
processing resources available at each PE;
storage resources available at each PE;
energy available at each PE for processing and communication; and
end-to-end communication performance between PEs (e.g., latency, throughput, packet loss rate, etc.).

The NWDAF uses this collected information as input to compute the requested/subscribed PE performance analytic. In computing this analytic, the NWDAF may also collect data from other NFs in 5GC. The analytic output may include statistics/predictions of one or more of the following:
performance between PE pairs in adjacent layers;
end-to-end performance through the processing network (e.g., PE₁ to PE_{N} in FIG. 5);
performance between the UE and each PE in the processing network; and
performance between the UE and a PE in the final layer of the processing network (e.g., from UE to PE_{N} in FIG. 5).
   Each of the statistics/predictions of performance may related to communication performance (e.g., latency, throughput, packet loss rate, etc.) and/or processing performance (e.g., computation or processing latency, storage availability, energy consumption, etc.).

The analytics outputs can be used at the AI/ML server to generate AI/ML assistance information. Based on the assistance information and current system environmental factors (e.g., communications data rate, available UE resources, etc.), the AI/ML server makes decisions about split AI/ML operations, such as one or more of the following:
selecting PE(s) of the processing network to perform the offloaded AI/ML operations;
selecting PE(s) for the UE to send its intermediate data (e.g., PE₁ in FIG. 5);
determining number of layers and/or PEs per layer; and
determining processing split point in the AI/ML operations, e.g., portion (or partition) of AI/ML operations to be performed by UE and by each PE/layer, etc.

In some embodiments, the analytic output may also include predictions and/or recommendations for splitting of AI/ML operations, such as which PEs to perform the offloaded operations, number of layers, splitting point, which PE(s) to receive UE intermediate results, etc. In such case, the AI/ML server may base its decisions on this information in the analytic.

The AI/ML server informs the UE about the decisions for split AI/ML operations. Based on this information, the UE executes the AI/ML operations up to the split point and sends the resulting intermediate data to the PEs (e.g., a server-indicated PE). The PEs in the processing network (e.g., as selected by the server) execute the offloaded parts of the AI/ML operations and send the results to the UE.

If the AI/ML server is in trusted domain, it can interact with NFs in 5GC (e.g., NWDAF) directly. If the AI/ML server is in an untrusted domain, it can interact with NFs in 5GC (e.g., NWDAF) via NEF, which may also convert the NWDAF analytic results to AI/ML assistance information.

FIG. 6 shows another exemplary system for split AI/ML operations based on offloading AI/ML tasks to a processing network with N layers of PEs, according to various embodiments of the present disclosure. In some embodiments, the system shown in FIG. 6 can be a different representation of the same system shown in FIG. 5. Unless expressly stated otherwise, entities in FIG. 6 can perform the same (or similar) operations as entities with the same names shown in FIG. 5, as described in more detail above.

In some embodiments, the AI/ML server may request/subscribe to one or more subsets of the analytic output for PE performance, and the NWDAF may perform operations to generate the requested/subscribed subset(s) accordingly. Likewise, the NWDAF server may generate only a subset of the analytic output for PE performance based on available data, regardless of the subscription or request from the AI/ML server. For example, if only data about communication performance in the processing network is available, then the NWDAF generates an analytic that only includes statistics/predictions of communication performance, such as between each pair of PEs, end-to-end, and/or between the UE and the PE(s) in the final layer.

In some embodiments, if the application logic for split AI/ML operations is known at the NWDAF, the outputs for predictions/recommendations on split operations, e.g., the PE(s) for the split inference operations, number of layers, split point, and the PE(s) for the UE to upload its spitted tasks, etc. could be generated.

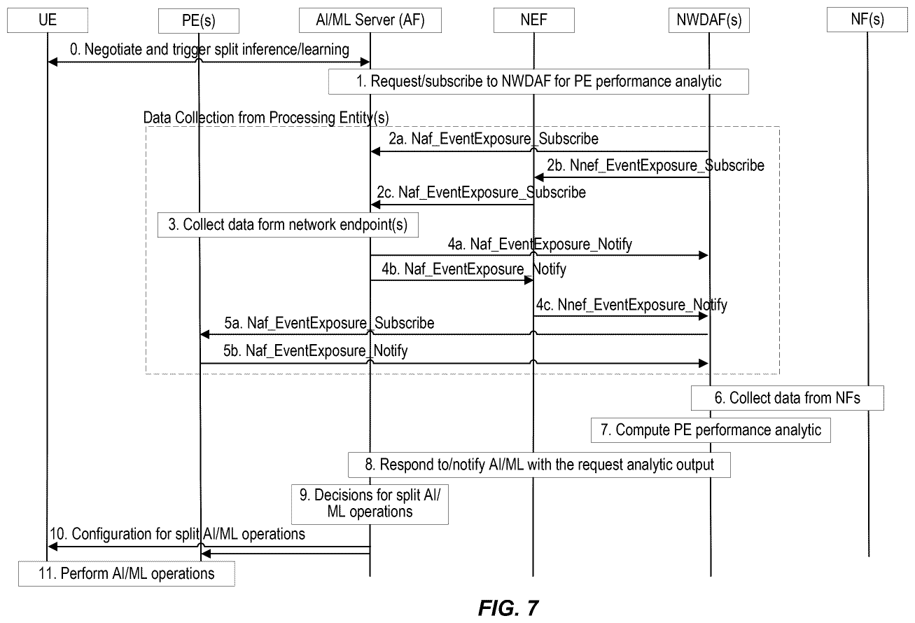

FIG. 7 shows a signaling diagram for an exemplary procedure for split AI/ML operations based on NWDAF-generated PE performance analytics, according to various embodiments of the present disclosure. The procedure is between a UE, one or more PEs, an AIML server (or AF), an NEF, one or more NWDAFs, and one or more other NFs of a 5GC. Although the operations in FIG. 7 are given numerical labels, this is done to facilitate the following description rather than to require or imply a sequential order of the operations, unless stated to the contrary. For simplicity, the description will refer to one or more entities (e.g., UEs) as a single entity (e.g., UE).

In operation 0, the UE sends the AI/ML server a request for split AI/ML operations. The request may include one or more of the following:
available UE resources (e.g., computation, storage, energy, etc.);
UE location;
processing and/or communication requirements of the split AI/ML operations (e.g., computation resources, task size, intermediate results size, UL/DL data rate, latency, reliability, etc.);
accuracy requirements for the split AI/ML operations;
area of interest for the split AI/ML operations; and
time window of interest for the split AI/ML operations.
   In response, the AI/ML server may provide information identifying the processing network (or PEs) for the split AI/ML operations, such as IP address(es), fully qualified domain name (FQDN), data network access identifier (DNAI), etc.

In operation 1, the AI/ML server (directly or via NEF) requests or subscribes to NWDAF(s) for PE performance analytics, by providing one or more of the following inputs:
Analytic ID, e.g., DN Performance, PE Performance, or similar name;
Area of Interest
Desired subset(s) of analytic output, including one or more of the following:
   performance between PE pairs in adjacent layers;
   end-to-end performance through the processing network;
   performance between a UE and each PE in the processing network;
   performance between a UE and a PE in the final layer of the processing network; and
   predictions and/or recommendations for splitting of AI/ML operations, such as discussed above.
Desired type of performance (for subset, if provided), such as communication performance, processing performance, or both communication and processing performance.

In some embodiments, the NWDAF subscribes to the AI/ML server for event exposure information concerning the PEs of the processing network (also referred to as network endpoints). This is done in operation 2, either directly (operation 2a) or indirectly via NEF (operations 2b-2c). In either case, the NWDAF's subscription request can indicate one or more of the following requested information:
computation resources available at each PE;
storage capacity available at each PE;
energy available for communication and computation at each PE;
communication performance between each pair of PEs (e.g., latency, throughput, packet loss rate, etc.)

In operation 3, the AI/ML server collects data from PE(s) according to the NWDAF's subscription request. In operation 4, the AI/ML server sends the collected information (or a processed version thereof) to the NWDAF, either directly (operation 4a) or via NEF (operations 4b-4c).

In other embodiments, the NWDAF subscribes directly to specific PEs of the processing network (e.g., as AFs) for event exposure information. For example, the NWDAF can invoke an Naf EventExposure Subscribe service operation towards the PEs (operation 5a), which can provide the requested information using an Naf EventExposure Notify service operation.

In operation 6, the NWDAF collects data from other NFs in 5GC. In operation 7, the NWDAF computes the requested PE performance analytic, e.g. “DN Performance”, “PE Performance”, or a similar name. In the case of the existing DN Performance analytics ID, the information collected from the PEs in operations 2-4 and 5 are new inputs. If the AI/ML server requested or subscribed to a subset and/or a specific type for the analytic in operation 1, the NWDAF may compute only the requested subset and/or type. As an illustrative example, if the AI/ML server subscribed only to a communication performance type of analytic, the NWDAF may compute one or more of the following (e.g., which may be according to subset information in the subscription request):
statistics and/or predictions of communication performance between PE pairs in adjacent layers;
statistics and/or predictions of end-to-end communication performance through the processing network;
statistics and/or predictions of communication performance between a UE and each PE in the processing network; and
statistics and/or predictions of communication performance between a UE and a PE in the final layer of the processing network.
   As another example, if the AI/ML server subscribed to predictions and/or recommendations for splitting of AI/ML operations, the NWDAF may determine such information if the application logic for split AI/ML operations is known by the NWDAF.

In operation 8, the NWDAF sends the requested analytic output to the AI/ML server (directly or via NEF). If the AI/ML server requested a subset and/or specific type for the analytic, the NWDAF provides the subset and/or type in accordance with the subscription request. In operation 9, the AI/ML server converts the received analytics to AI/ML assistance information. If the NWDAF send the requested analytic output via NEF, the NEF may perform the conversion of operation 9 and send the AI/ML assistance information to the AI/ML server. In either case, based on the assistance information and current system environmental factors (e.g., communications data rate, available UE resources, etc.), the AI/ML server makes decisions about split AI/ML operations, such as one or more of the following:
selecting PE(s) of the processing network to perform the offloaded AI/ML operations;
selecting PE(s) for the UE to send its intermediate data (e.g., PE₁ in FIG. 5);
determining number of layers and/or PEs per layer;
determining processing split point in the AI/ML operations, e.g., portion (or partition) of AI/ML operations to be performed by UE and by each PE/layer, etc.; and
determining time period and/or energy consumption budget for performing the split AI/ML operations.

In some embodiments, the analytic output may also include predictions and/or recommendations for splitting of AI/ML operations, such as which PEs to perform the offloaded operations, number of layers, splitting point, which PE(s) to receive UE intermediate results, etc. In such case, the AI/ML server may base its decisions in operation 9 on this analytic information.

In operation 10, the AI/ML server informs the UE and the PEs about the decisions for split AI/ML operations. In operation 11, based on this information, the UE executes the AI/ML operations up to the split point and sends the resulting intermediate data to the PEs (e.g., a server-indicated PE). The PEs in the processing network (e.g., as selected by the server) execute the offloaded parts of the AI/ML operations and send the results to the UE.

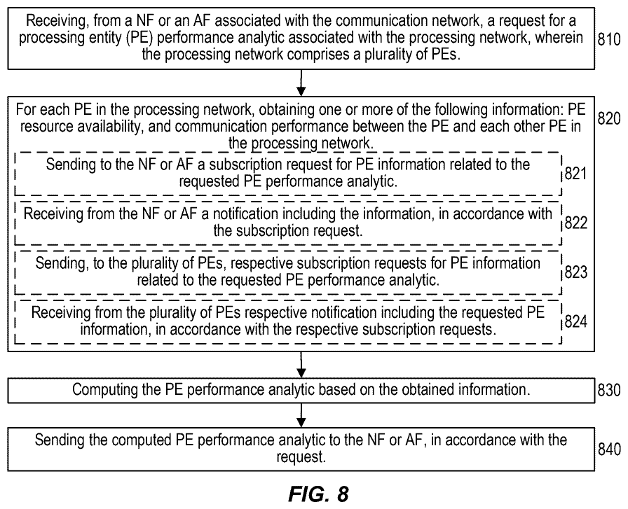

The embodiments described above can be further illustrated with reference to FIGS. 8-10, which depict an exemplary methods (e.g., procedures) for an NWDAF, an AI/ML server, and a processing network, according to various embodiments of the present disclosure. Put differently, various features of the operations described below correspond to various embodiments described above. The exemplary methods shown in FIGS. 8-10 can be performed cooperatively to provide various benefits and/or advantages described herein. Although the exemplary methods are illustrated in FIGS. 8-10 by specific blocks in particular orders, the operations corresponding to the blocks can be performed in different orders than shown and can be combined and/or divided into blocks and/or operations having different functionality than shown. Optional blocks and/or operations are indicated by dashed lines.

In particular, FIG. 8 shows an exemplary method (e.g., procedure) for an NWDAF configured to assist splitting of AI/ML operations between a UE and a processing network that are operably coupled via a communication network, according to various embodiments of the present disclosure. The exemplary method shown in FIG. 8 can be performed by an NWDAF (or network node hosting the same) such as described elsewhere herein.

The exemplary method can include the operations of block 810, where the NWDAF can receive, from a network function (NF) or an application function (AF) associated with the communication network, a request for a processing entity performance (PE) analytic associated with the processing network, which includes a plurality of PEs. The exemplary method can also include the operations of block 820, where for each PE in the processing network, the NWDAF can obtain one or more of the following information: PE resource availability, and communication performance between the PE and each other PE in the processing network. The exemplary method can also include the operations of block 830, where the NWDAF can compute the PE performance analytic based on the obtained information. The exemplary method can also include the operations of block 840, where the NWDAF can send the computed PE performance analytic to the NF or AF, in accordance with the request.

In some embodiments, the PE performance analytic includes statistics and/or predictions of one or more of the following:
performance between PE pairs in adjacent layers of the processing network;
end-to-end performance through the processing network;
performance between the UE and each PE in the processing network; and
performance between the UE and a PE in a final layer of the processing network.

In some of these embodiments, the statistics and/or predictions of performance are for one or more of the following performance types: processing performance, and communication performance. In some of these embodiments, the PE performance analytic also includes predictions and/or recommendations for splitting of AI/ML operations between the UE and the processing network, including one or more of the following:
one or more PEs recommended for performing AI/ML operations offloaded from the UE,
one or more PEs recommended to receive intermediate results of UE AI/ML operations;
a number of layers in the processing network and/or a number of PEs per layer recommended for the AI/ML operations offloaded from the UE; and
a recommended split point or partition between AI/ML operations performed by the UE and AI/ML operations performed by the processing network.

In some embodiments, the request for the PE performance analytic includes one or more of the following: analytics identifier (ID), area of interest, requested subset of available analytic results, and requested performance type. In some of these embodiments, the requested subset of available analytic results include one or more of the following:
performance between PE pairs in adjacent layers of the processing network;
end-to-end performance through the processing network;
performance between the UE and each PE in the processing network; and
performance between the UE and a PE in a final layer of the processing network; and
predictions and/or recommendations for splitting of AI/ML operations between the UE and the processing network.
   In some of these embodiments, the requested performance type includes one or more of the following: processing performance, and communication performance.

In some embodiments, the NF or AF is one of the following: an AI/ML server, or a network exposure function (NEF) operably coupled to the AI/ML server.

In some embodiments, obtaining the information for each PE in the processing network in block 820 includes the operations of sub-blocks 821-822, wherein the NWDAF can send to the NF or AF a subscription request for PE information related to the requested PE performance analytic, and receiving from the NF or AF a notification including the information, in accordance with the subscription request.

In other embodiments, obtaining the information for each PE in the processing network in block 820 includes the operations of sub-blocks 823-824, wherein the NWDAF can send to the plurality of PEs respective subscription requests for PE information related to the requested PE performance analytic, and receive from the plurality of PEs respective notification including the requested PE information, in accordance with the respective subscription requests.

In some embodiments, for each PE, the PE resource availability information includes indications of one or more of the following: processing resources available at the PE, storage resources available at the PE, and energy available at the PE for processing and communication.

In some embodiments, computing the PE performance analytic in block 830 is further based on information obtained from one or more other NFs of the communication network.

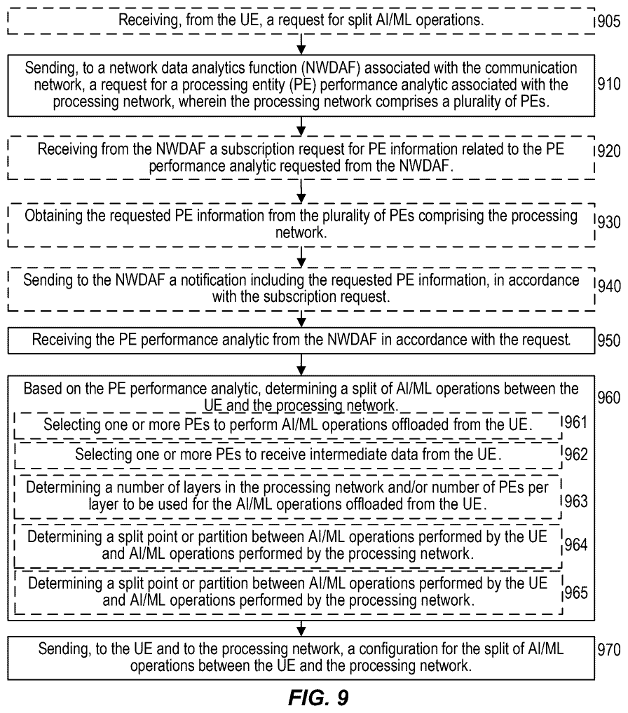

In addition, FIG. 9 shows an exemplary method (e.g., procedure) for an AI/ML server configured to support splitting of AI/ML operations between a UE and a processing network that are operably coupled via a communication network, according to various embodiments of the present disclosure. The exemplary method shown in FIG. 9 can be performed by an AI/ML server (e.g., AF, within or outside of a communication network) such as described elsewhere herein.

The exemplary method can include the operations of block 910, where the AI/ML server can send, to an NWDAF associated with the communication network, a request for a PE performance analytic associated with the processing network, which includes a plurality of PEs. The exemplary method can also include the operations of block 950, where the AI/ML server can receive the PE performance analytic from the NWDAF in accordance with the request. The exemplary method can also include the operations of block 960, where based on the PE performance analytic, the AI/ML server can determine a split of AI/ML operations between the UE and the processing network. The exemplary method can also include the operations of block 970, where the AI/ML server can send, to the UE and to the processing network, a configuration for the split of AI/ML operations between the UE and the processing network.

In various embodiments, the PE performance analytic can include any of the same information as the corresponding analytic described above in relation to NWDAF embodiments. In various embodiments, the request for the PE performance analytic can include any of the same information as the corresponding request described above in relation to NWDAF embodiments.

In some embodiments, determining the split of AI/ML operations based on the PE performance analytic in block 960 includes one or more of the following operations, labelled with corresponding sub-block numbers:
(961) selecting one or more PEs to perform AI/ML operations offloaded from the UE;
(962) selecting one or more PEs to receive intermediate data from the UE;
(963) determining a number of layers in the processing network and/or number of PEs per layer to be used for the AI/ML operations offloaded from the UE;
(964) determining a split point or partition between AI/ML operations performed by the UE and AI/ML operations performed by the processing network; and
(965) determining a time period and/or an energy consumption budget for performing the split AI/ML operations.

In some embodiments, the exemplary method can also include the operations of block 905, where the AI/ML server can receive from the UE a request for split AI/ML operations. In such case, the request for the PE performance analytic (e.g., in block 910) is based on the request from the UE. In some of these embodiments, the request from the UE includes one or more of the following information: available UE resources, UE location, processing and/or communication requirements for the split AI/ML operations, accuracy requirements for the split AI/ML operations, area of interest for the split AI/ML operations, and time window of interest for the split AI/ML operations. In some of these embodiments, determining the split of AI/ML operations in block 960 is further based on the information included with the request from the UE.

In some embodiments, the exemplary method can also include the operations of blocks 920-940, where the AI/ML server can receive from the NWDAF a subscription request for PE information related to the PE performance analytic requested from the NWDAF, obtain the requested PE information from the plurality of PEs comprising the processing network, and send to the NWDAF a notification including the requested PE information, in accordance with the subscription request. In some of these embodiments, the subscription request is received from, and the network sent to, the NWDAF according to one of the following: directly, or via a network exposure function (NEF) of the communication network.

In some of these embodiments, for each PE, the PE information obtained (e.g., in block 930) and sent (e.g., in block 940) includes one or more of the following: PE resource availability, and communication performance between the PE and each other PE in the processing network. In some variants, for each PE, the PE resource availability information includes indications of one or more of the following: processing resources available at the PE, storage resources available at the PE, and energy available at the PE for processing and communication.

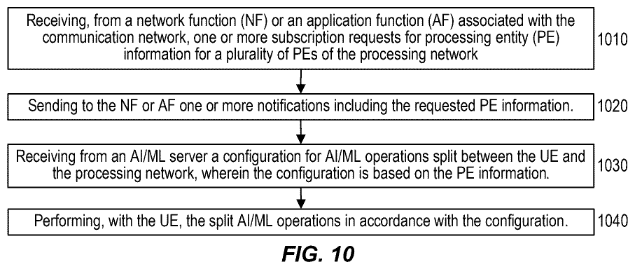

In addition, FIG. 10 shows an exemplary method (e.g., procedure) for a processing network configured to support split AI/ML operations with a UE that is operably coupled to the processing network via a communication network, according to various embodiments of the present disclosure. The exemplary method shown in FIG. 10 can be performed by a processing network (e.g., one or more servers, cloud computing environment, etc., within or outside of a communication network) such as described elsewhere herein.

The exemplary method can include the operations of block 1010, where the processing network can receive, from a NF or an AF associated with the communication network, one or more subscription requests for PE information for a plurality of PEs of the processing network. The exemplary method can also include the operations of block 1020, where the processing network can send to the NF or AF one or more notifications including the requested PE information. The exemplary method can also include the operations of block 1030, where the processing network can receive from an AI/ML server a configuration for AI/ML operations split between the UE and the processing network, wherein the configuration is based on the PE information. The exemplary method can also include the operations of block 1040, where the processing network can perform, with the UE, the split AI/ML operations in accordance with the configuration.

In some embodiments, the NF or AF is the AI/ML server. In other embodiments, the NF or AF is a network exposure function (NEF).

In some embodiments, the configuration for split AI/ML operations includes indications of one or more of the following:
one or more PEs to perform AI/ML operations offloaded from the UE;
one or more PEs to receive intermediate data from the UE;
a number of layers in the processing network and/or a number of PEs per layer to be used for the AI/ML operations offloaded from the UE;
a split point or partition between AI/ML operations performed by the UE and AI/ML operations performed by the processing network; and
a time period and/or an energy consumption budget for performing the split AI/ML operations.

In some embodiments, for each PE, the PE information sent (e.g., in block 1020) includes one or more of the following: PE resource availability, and communication performance between the PE and each other PE in the processing network. In some of these embodiments, for each PE, the PE resource availability information includes indications of one or more of the following: processing resources available at the PE, storage resources available at the PE, and energy available at the PE for processing and communication.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

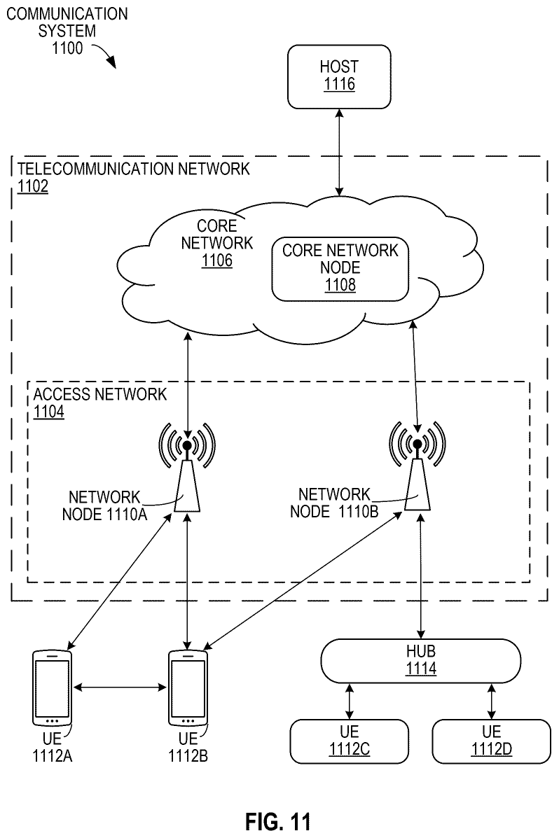

FIG. 11 shows an example of a communication system 1100 in accordance with some embodiments. In this example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3GPP access node or non-3GPP access point. The network nodes 1110 facilitate direct or indirect connection of UEs, such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a specific example, host 1116 can be configured to perform various methods (e.g., procedures) described herein as being performed by a processing network (or a PE of a processing network). Similarly, one or more core network nodes 1108 can be configured to perform various methods (e.g., procedures) described herein as being performed by an NWDAF and an AI/ML server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

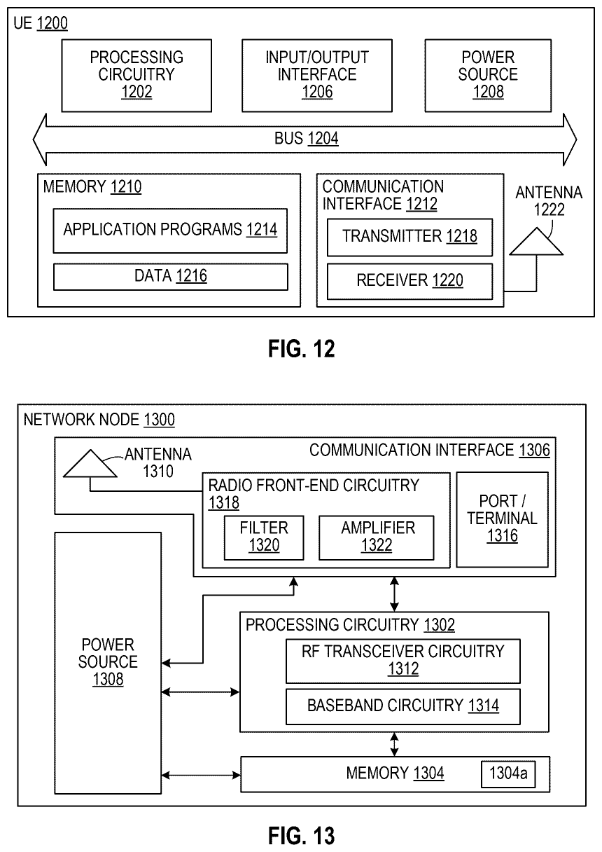

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions (collectively denoted computer program product 1304a) capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment.

Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

As a specific example, one or more network nodes 1300 can be configured to perform various methods (e.g., procedures) described herein as being performed by an NWDAF and an AI/ML server.

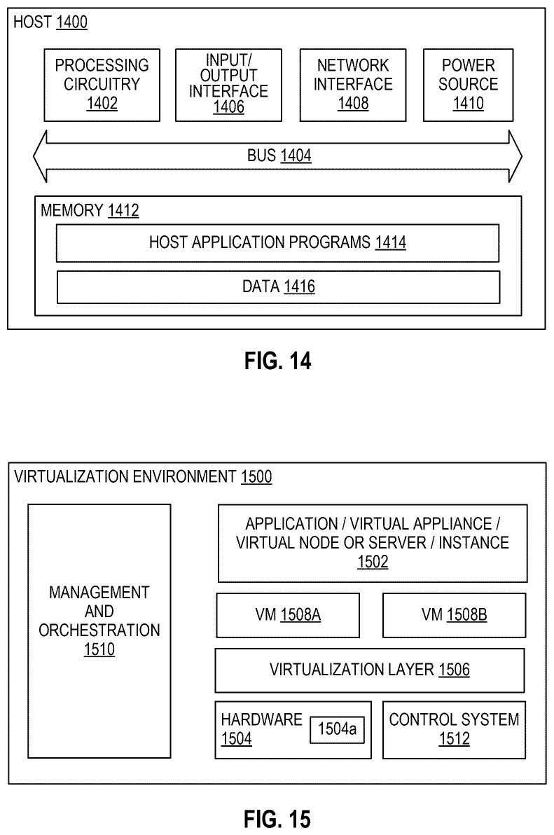

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

As a specific example, host 1400 can be configured to perform various methods (e.g., procedures) described herein as being performed by a processing network (or a PE of a processing network).

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

As a specific example, NWDAFs and AI/ML servers described herein can be implemented as a software instance, a virtual appliance, a network function, a virtual node, or a virtual network function in virtualization environment 1500. As such, hardware 1504 can perform operations attributed to such NWDAFs and AI/ML servers in various methods or procedures described above.

Hardware 1504 includes processing circuitry, memory that stores software and/or instructions (collectively denoted computer program product 1504a) executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g., in a data center) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

For example, hardware 1504 and/or one or more VMs 1508 may be arranged as one or more processing entities (PEs) of a processing network such as described herein. As such, hardware 1504 and/or one or more VMs 1508 can perform operations attributed to such processing networks in various methods or procedures described above.

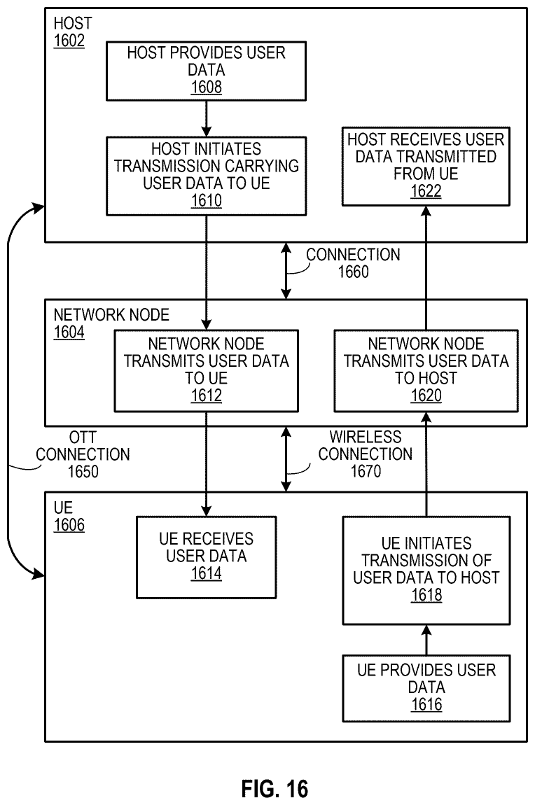

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, embodiments expose beneficial assistance information to AI/ML endpoints (e.g., UE, AI/ML server, etc.), thereby enabling the AI/ML endpoints to make more accurate decisions for task offloading in split AI/ML operations. In this manner, embodiments facilitate the use of split AI/ML architectures for various applications run over a communication network (e.g., 5G network). More generally, embodiments facilitate deployment of application layer AI/ML that relies on information from a communication network (e.g., 5GC), which can improve performance of applications—such as OTT services—that communicate via the communication network. This can increase the value of such OTT services to end users and service providers.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. A method for a network data analytics function, NWDAF, configured to assist splitting of artificial intelligence/machine learning, AI/ML, operations between a user equipment, UE, and a processing network that are operably coupled via the communication network, the method comprising:
receiving, from a network function, NF, or an application function, AF, associated with the communication network, a request for a processing entity, PE, performance analytic associated with the processing network, wherein the processing network comprises a plurality of PEs;
for each PE in the processing network, obtaining one or more of the following information: PE resource availability, and communication performance between the PE and each other PE in the processing network;
computing the PE performance analytic based on the obtained information; and
sending the computed PE performance analytic to the NF or AF, in accordance with the request.

2. The method of claim 1, wherein the PE performance analytic includes statistics and/or predictions of one or more of the following:
performance between PE pairs in adjacent layers of the processing network;
end-to-end performance through the processing network;
performance between the UE and each PE in the processing network; and
performance between the UE and a PE in a final layer of the processing network.

3. The method of claim 2, wherein the statistics and/or predictions of performance are for one or more of the following performance types: processing performance, and communication performance.

4. The method of claim 2, wherein the PE performance analytic also includes predictions and/or recommendations for splitting of AI/ML operations between the UE and the processing network, including one or more of the following:
one or more PEs recommended for performing AI/ML operations offloaded from the UE,
one or more PEs recommended to receive intermediate results of UE AI/ML operations;
a number of layers in the processing network and/or a number of PEs per layer recommended for the AI/ML operations offloaded from the UE; and
a recommended split point or partition between AI/ML operations performed by the UE and AI/ML operations performed by the processing network.

5. The method of claim 1, wherein the request for the PE performance analytic includes one or more of the following: analytics identifier, ID, area of interest, requested subset of available analytic results, and requested performance type.

6. The method of claim 5, wherein the requested subset of available analytic results include one or more of the following:
performance between PE pairs in adjacent layers of the processing network;
end-to-end performance through the processing network;
performance between the UE and each PE in the processing network; and
performance between the UE and a PE in a final layer of the processing network; and
predictions and/or recommendations for splitting of AI/ML operations between the UE and the processing network

7. The method of claim 5, wherein the requested performance type includes one or more of the following: processing performance, and communication performance.

8. The method of claim 1, wherein the NF or AF is one of the following: an AI/ML server, or a network exposure function, NEF, operably coupled to the AI/ML server.

9. The method of claim 1, wherein obtaining the information for each PE in the processing network comprises:
sending to the NF or AF a subscription request for PE information related to the requested PE performance analytic; and
receiving from the NF or AF a notification including the information, in accordance with the subscription request.

10. The method of claim 1, wherein obtaining the information for each PE in the processing network comprises:
sending, to the plurality of PEs, respective subscription requests for PE information related to the requested PE performance analytic; and
receiving from the plurality of PEs respective notification including the requested PE information, in accordance with the respective subscription requests.

11. The method of claim 1, wherein for each PE, the PE resource availability information includes indications of one or more of the following:
processing resources available at the PE;
storage resources available at the PE; and
energy available at the PE for processing and communication.

12. The method of claim 1, wherein computing the PE performance analytic is further based on information obtained from one or more other NFs of the communication network.

13. A method for an artificial intelligence/machine learning, AI/ML, server configured to support splitting of AI/ML operations between a user equipment, UE, and a processing network that are operably coupled via a communication network, the method comprising:
sending, to a network data analytics function, NWDAF, associated with the communication network, a request for a processing entity performance, PE, analytic associated with the processing network, wherein the processing network comprises a plurality of PEs;
receiving the PE performance analytic from the NWDAF in accordance with the request;
based on the PE performance analytic, determining a split of AI/ML operations between the UE and the processing network; and
sending, to the UE and to the processing network, a configuration for the split of AI/ML operations between the UE and the processing network.

14. The method of claim 13, wherein the PE performance analytic includes statistics and/or predictions of one or more of the following:
performance between PE pairs in adjacent layers of the processing network;
end-to-end performance through the processing network;
performance between the UE and each PE in the processing network; and
performance between the UE and a PE in a final layer of the processing network.

15. The method of claim 14, wherein the statistics and/or predictions of performance are for one or more of the following performance types: processing performance, and communication performance.

16. The method of claim 14, wherein the PE performance analytic also includes predictions and/or recommendations for splitting of AI/ML operations between the UE and the processing network, including one or more of the following:
one or more PEs recommended for performing AI/ML operations offloaded from the UE,
one or more PEs recommended to receive intermediate results of UE AI/ML operations;
a number of layers in the processing network and/or a number of PEs per layer recommended for the AI/ML operations offloaded from the UE; and
a recommended split point or partition between AI/ML operations performed by the UE and AI/ML operations performed by the processing network.

17. The method of claim 13, wherein the request for the PE performance analytic includes one or more of the following: analytics identifier, ID, area of interest, requested subset of available analytic results, and requested performance type.

18. The method of claim 17, wherein the requested subset of available analytic results include one or more of the following:
performance between PE pairs in adjacent layers of the processing network;
end-to-end performance through the processing network;
performance between the UE and each PE in the processing network; and
performance between the UE and a PE in a final layer of the processing network; and
predictions and/or recommendations for splitting of AI/ML operations between the UE and the processing network

19. The method of claim 17, wherein the requested performance type includes one or more of the following: processing performance, and communication performance.

20. The method of claim 13, wherein determining the split of AI/ML operations based on the PE performance analytic includes one or more of the following:
selecting one or more PEs to perform AI/ML operations offloaded from the UE;
selecting one or more PEs to receive intermediate data from the UE;
determining a number of layers in the processing network and/or number of PEs per layer to be used for the AI/ML operations offloaded from the UE;
determining a split point or partition between AI/ML operations performed by the UE and AI/ML operations performed by the processing network; and
determining a time period and/or an energy consumption budget for performing the split AI/ML operations.

21-33. (canceled)

34. A network data analytics function, NWDAF, of a communication network, wherein the NWDAF is configured to assist splitting of artificial intelligence/machine learning, AI/ML, operations between a user equipment, UE, and a processing network that are operably coupled via the communication network, wherein the NWDAF is further configured to perform operations corresponding to the method of claim 1.

35-37. (canceled)

38. An artificial intelligence/machine learning, AI/ML, server configured to support splitting of AI/ML operations between a user equipment, UE, and a processing network that are operably coupled via a communication network, the AI/ML server being configured to perform operations corresponding to the method of claim 13.

39-44. (canceled)
